(19) United States
(12) Patent Application Publication
(10) Pub. No.: US 2015/0269505 A1
(43) Pub. Date: Sep. 24, 2015

(54) Operation Support System for Plant Accidents

(71) Applicant: Hitachi, Ltd., Tokyo (JP)

(72) Inventors: Setsuo ARITA, Tokyo (JP); Yoshihiko ISHII, Tokyo (JP); Masaki KANADA, Tokyo (JP); Ryota KAMOSHIDA, Tokyo (JP); Kenichi KATONO, Tokyo (JP); Tadaaki ISHIKAWA, Tokyo (JP)

(21) Appl. No.: 14/625,720

(22) Filed: Feb. 19, 2015

(30) Foreign Application Priority Data
Mar. 18, 2014 (JP) 2014-054298

(51) Int. Cl. G06Q 10/06

(52) U.S. Cl. CPC G06Q 10/0635

(57) ABSTRACT

An object of the invention is to provide an operation support system for plant accidents that estimates events reflecting plant states changing momentarily at plant accidents. The invention includes an event narrow-down device that narrows down occurring event candidates based on at least one of a sensor signal, a device state signal, and an alarm signal and a discriminant rule, an event analysis device that analyzes a plant behavior based on a plurality of event narrow-down results as output of the event narrow-down device, the sensor signal, the device state signal, and the alarm signal, and an event estimation device that estimates an occurring event by comparing an analysis result from an analysis of a process state as output of the event analysis device and the sensor signal, wherein the event estimation device outputs the analysis result of the process state and the sensor signal corresponding to the occurring event as an event estimation result.

### BACKGROUND OF THE INVENTION

1. Field of the Invention

The present invention relates to an operation support system for plant accidents.

2. Description of the Related Art

In various plants including nuclear power plants, thermal power plants, and chemical plants, when abnormalities and accidents occur, it is necessary for operators to promptly grasp the states of the plants and take appropriate responses. As support for operators when abnormalities and accidents occur, Patent Document 1 (JP-A-7-181292) discloses a state estimation apparatus that can estimate process states of a plant.

In Patent Document 1, a plurality of device model formulae are provided, observation signals as sensor signals are input to the device model formulae, and output signals corresponding to the input/output characteristics of the device model formulae are output as process states of the plant. The device models are prepared in advance and, for example, if an object device of the prepared device model breaks down, it is impossible to output an output signal reflecting the failure of the device. As a result, there is a problem that it becomes impossible to output a change in process of the plant in response to the plant state. Further, even when a device model assuming the failure of the device is prepared, if no means for determining the failure of the device is provided, it is impossible to determine what kind of failure occurs, and there is a problem that it is impossible to estimate the plant state reflecting the device state of the plant.

### SUMMARY OF THE INVENTION

The invention has been achieved in view of the above described problems, and an object of the invention is to provide an operation support system for plant accidents that estimates events reflecting plant states changing momentarily at plant accidents.

An operation support system for plant accidents according to the invention includes an event narrow-down device that narrows down occurring event candidates based on at least one of a sensor signal, a device state signal, and an alarm signal and a discriminant rule, an event analysis device that analyzes a plant behavior based on a plurality of event narrow-down results as output of the event narrow-down device, the sensor signal, the device state signal, and the alarm signal, and an event estimation device that estimates an occurring event by comparing an analysis result from an analysis of a process state as output of the event analysis device and the sensor signal, wherein the event estimation device outputs the analysis result of the process state and the sensor signal corresponding to the occurring event as an event estimation result.

According to the invention, an operation support system for plant accidents that estimates events reflecting plant states changing momentarily at plant accidents may be provided.

### BRIEF DESCRIPTION OF THE DRAWINGS

FIG. 1 is one configuration diagram of an operation support system for plant accidents as example 1 of the invention.

FIG. 2 shows an example of event narrow-down using alarm information.

FIG. 3 is an explanatory diagram of an event analysis model.

FIG. 4 shows a condition in which sensor signals and analysis results of events are not temporally synchronized.

FIG. 5 shows a condition in which sensor signals and analysis results of events are temporally synchronized.

FIG. 6 shows an example of a relationship between event narrow-down and event analysis.

FIG. 7 is one configuration diagram of an operation support system for plant accidents as example 2 of the invention.

FIG. 8 is one configuration diagram of an operation support system for plant accidents as example 3 of the invention.

FIG. 9 shows a progress prediction result after device operation.

FIG. 10 is one configuration diagram of an operation support system for plant accidents as example 4 of the invention.

FIG. 11 shows one example of a nuclear plant system to which the operation support system for plant accidents according to the invention is applied.

### DETAILED DESCRIPTION OF THE EMBODIMENTS

The invention relates to an operation support system for plant accidents and an operation support method for plant accidents that support operation of a plant at accidents by identification of plant states including sensors at accidents. As below, the respective examples will be explained.

### Example 1

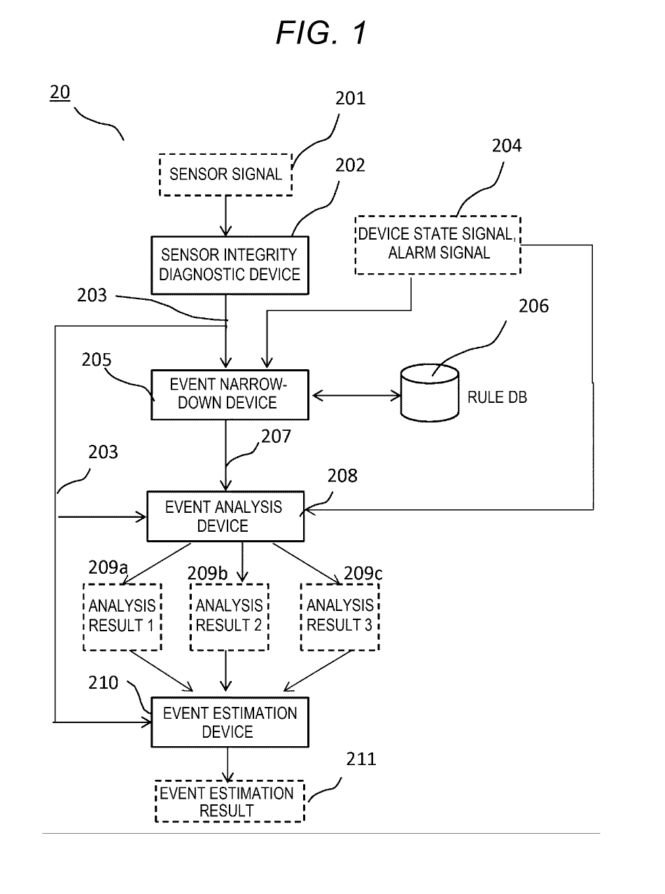

As below, the example will be explained with reference to the drawings. FIG. 1 is one configuration diagram of an operation support system for plant accidents as the example, and the explanation will be made with a nuclear plant as a representative.

Sensor signals 201 are process signals of a temperature, pressure, a water level, a flow rate, or the like of the plant, and 204 denotes device state signals and alarm signals. These signals are generated by an alarm processing system, a controller, and a process calculator (not shown). The device state signal is a state signal of start/stop, open/close of a pump, a valve, or the like which is a device of the plant. The sensor signals 201 are taken in a sensor integrity diagnostic device 202, and abnormal sensor signals are removed and normal signals 203 are taken in an event narrow-down device 205. Regarding the redundant sensors in terms of hardware, the signal of the sensor outputting the abnormal value by majority decision of the output signals is excluded by the sensor integrity diagnostic device 202. Further, regarding the analytically redundant sensors (e.g., a plurality of correlated sensors), the signal of the sensor deviated from the correlation is excluded by the sensor integrity diagnostic device 202. Information representing the abnormal sensor is separately output from the sensor integrity diagnostic device 202. The normal sensor signals 203 are used not only in the event narrow-down device 205 but also in an event analysis device 208 and an event estimation device 210. 20 denotes an operation support system for plant accidents.

A rule DB (database) 206 stores discriminant rules for various events. The event narrow-down device 205 narrows down occurring event candidates from the discriminant rules for various events, the normal sensor signals 203, the device state signals, and the alarm signals 204 which are input to the event narrow-down device. When the event candidates are narrowed down, at least one of the sensor signals 203, the device state signals, and the alarm signals 204 may be used. In the narrow-down of the event candidates, a naive Bayes classifier may be used for event narrow-down using alarm information and a DP matching (dynamic programming) for event narrow-down by comparison with reference values using sensor information may be used.

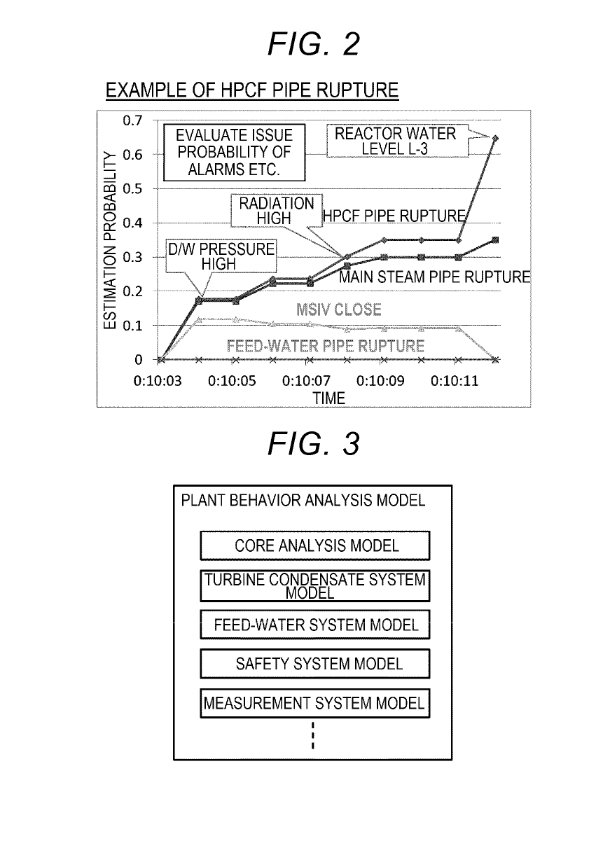

For example, FIG. 2 shows an example of event narrow-down using alarm information. As an event, an example of HPCF (high-pressure core flooder) pipe rupture is shown. In an initial state (at 10 minutes 3 seconds), there is no event candidate. Event candidates are narrowed down based on alarms issued every second and, first, after a lapse of one second, narrowed down to feed-water pipe rupture, MSIV (main steam isolation valve) close, main stream pipe rupture, HPCF pipe rupture. The vertical axis indicates estimation probability. The estimation probability of MSIV close is not zero, but very low. The estimation probability is obtained based on the alarms issued every second. In FIG. 2, characteristic alarms are shown by balloons. When an alarm “D/W pressure high” is issued, the estimation probabilities of HPCF pipe rupture and main stream pipe rupture are the highest, and the estimation probability of MSIV close is the second highest. When an alarm “radiation high” is issued, the estimation probability of HPCF pipe rupture is the highest, the estimation probability of main stream pipe rupture is the second highest, and the estimation probability of MSIV close becomes slightly lower. When an alarm “reactor water level L-3” is issued, the estimation probability of HPCF pipe rupture becomes higher, and the estimation probability of MSIV close is nearly zero. As described above, the occurring events may be narrowed down using the alarm signals.

Further, in the above described example, with respect to the occurring event “HPCF pipe rupture”, as the narrowed down events, the estimation probability of HPCF pipe rupture is higher than those of the other narrowed down events. However, it is conceivable that, with respect to other occurring events, the estimation probabilities of the narrowed down events may not largely different. In this case, if the events are narrowed down only to the event indicating the highest estimation probability, the event narrow-down may be wrong. Accordingly, a plurality of event narrow-down results 207 (pluralities of occurring events narrowed down, sensor signals, alarm signals, device state signals) are output from the event narrow-down device 205. As a result, an event with coincidence between an analysis result of an analysis of the plant state, which will be described later, and the sensor signal may be extracted from a plurality of event candidates, and the accuracy of the event estimation is improved. Further, by narrow-down of a plurality of events, in the case where a complex event (e.g., main steam isolation valve rupture and HPCF pump inoperative) occurs, the estimation probability may fluctuate due to deviation of occurrence times, and there is an advantage that the extraction accuracy is improved in event narrow-down of complex events.

The plurality of event narrow-down results, the sensor signals, the alarm signals, the device state signals as the output signals from the event narrow-down device 205 are input, and the event analysis device 208 analyzes a behavior of the plant. The sensor signals, the alarm signals, the device state signals are provided as boundary conditions of the plant behavior analysis. Models for analyzing the plant behavior include e.g., core analysis models (a nuclear dynamic characteristic model, a fuel behavior analysis model, a thermal hydraulic model), a turbine condensate system model, a feed-water system model, safety system models (a high-pressure core cooling system model, a low-pressure flooder system model, an isolation cooling system model, a residual heat removal system model, an auto-depressurization system model), a measurement system model, etc. Particularly, the safety system model has an automatic start condition of a device of the safety system and, when the sensor signal indicating the process state exceeds the automatic start condition, starts at least the device model of the safety system and analyzes the plant behavior in a predetermined time range. Therefore, the process state including the operation of the safety system at accidents may be estimated. As a result, the event analysis device 208 may analyze the plant behavior and estimate the process state in the predetermined time range with respect to each of the plurality of events narrowed down by the event narrow-down device 205, and outputs the results as analysis results associated with the narrowed-down events. 209a denotes an analysis result 1, 209b denotes an analysis result 2, and 209c denotes an analysis result 3. The analysis results associated with the plurality of events are output to the event estimation device 210.

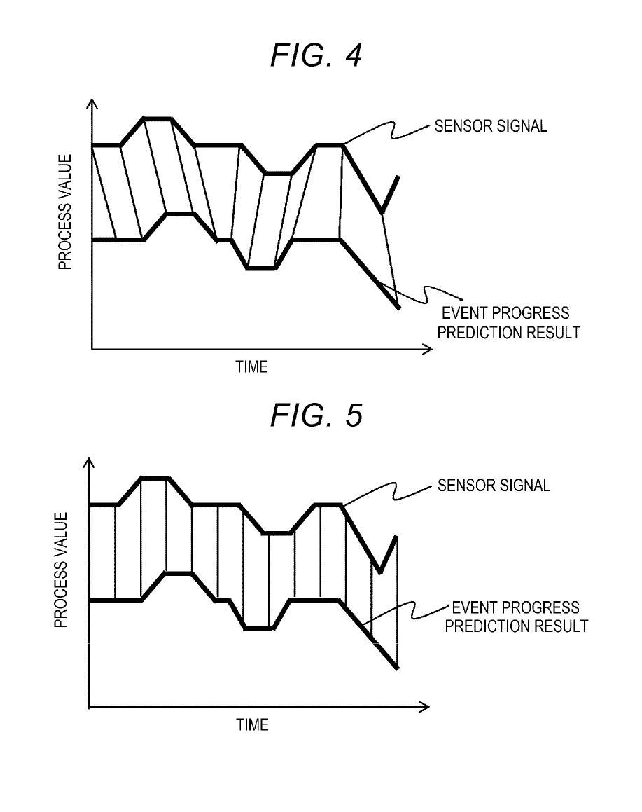

The event estimation device 210 compares the analysis results associated with the plurality of events (process states) and the sensor signals 203, and an occurring event with coincidence between them is output with the sensor signal 203 and the analysis result 209 as an event estimation result 211. For comparison, it is preferable to synchronize the times of the analysis result associated with each event and the sensor signal, however, there is no guarantee that the event analysis device 208 executes the calculation at the same speed as actual time. When the time of the sensor signal and the time lapse of the analysis result are different, the event narrow-down result is output, in synchronization with the time to start event analysis by the event analysis device 208, regarding both signals having temporal differences as shown in FIG. 4, the start times of both signals are synchronized and a comparison range of the signals is set. As event estimation, similarity is evaluated as to whether or not the signals coincide, and the event with the highest similarity is determined. As similarity calculation, it is convenient to use dynamic time warping in consideration of the time deviation of the signals.

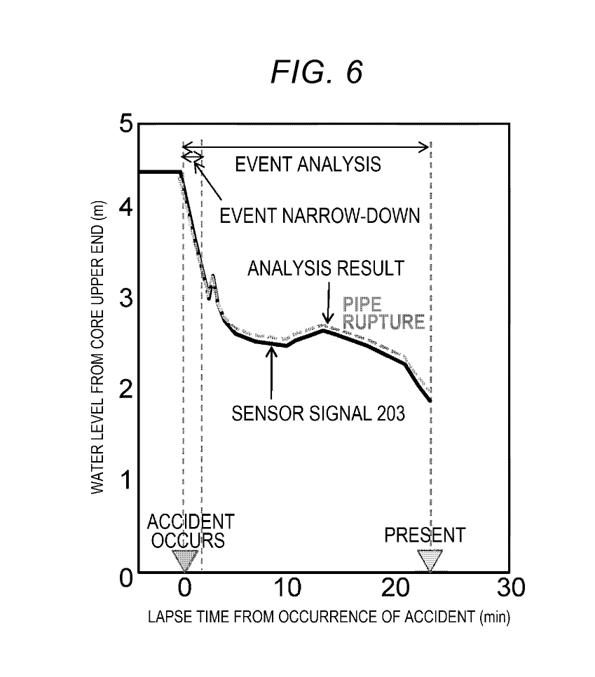

FIG. 6 shows an example of a relationship between event narrow-down and event analysis. The event estimation device 210 can output the event analysis result and the sensor signal 203 (process state) to a display device (not shown), and there is an advantage that an operator in a central control room and a technical supporter of a technical support center (technical support organization) may confirm the degree of the difference between the analysis result and the process state of the plant. When the related events are narrowed down, plant behavior analyses with respect to the narrowed down events are performed and the process states in the predetermined time range are output. In this regard, the plant state changes momentarily, and analyses with the state changes of the devices (pump start, pump stop, valve close, valve open, etc.) are performed. In the drawing, the example in which the event analysis is performed from the time at an accident is shown, however, the event analysis may be performed from the time when the event narrow-down result is output. The process state in the predetermined time range is analyzed for improvement in accuracy of the event estimation. The water level from the core upper end after completion of the event narrow-down once rises and then falls because a certain device operates. In the event analysis, the automatic start condition of the device of the safety system is provided, and thereby, the same behavior as the result of the sensor signal 203 may be simulated. The event estimation device 210 can output the event estimation result and the sensor signal 203 (process state) to the display device (not shown). As a result, there is an advantage that coincidence of the behavior (process state) of the real plant with the event estimation result may be confirmed by comparison on the display device.

In the example, the plant states are narrowed down based on at least one of the sensor signal, the alarm signal, and the device state signal, with at least the event narrow-down result as the initial condition of the plant behavior analysis, the process state of the plant is estimated with respect to the narrowed down event candidates, the analysis result and the sensor signal of the plant are compared, and the event candidate with coincidence or the highest similarity is output as the occurring event, and thereby, there is an advantage that the event may be estimated in reflection of the state of the plant changing momentarily.

Further, in the example, the event analysis device has the automatic start condition of the safety system and, when the sensor signal indicating the process state exceeds the automatic start condition, starts at least the safety system model and analyzes the plant behavior, and thereby, the process state reflecting the operation status of the safety system that operates at accidents may be estimated, and the estimation accuracy is further improved.

### Example 2

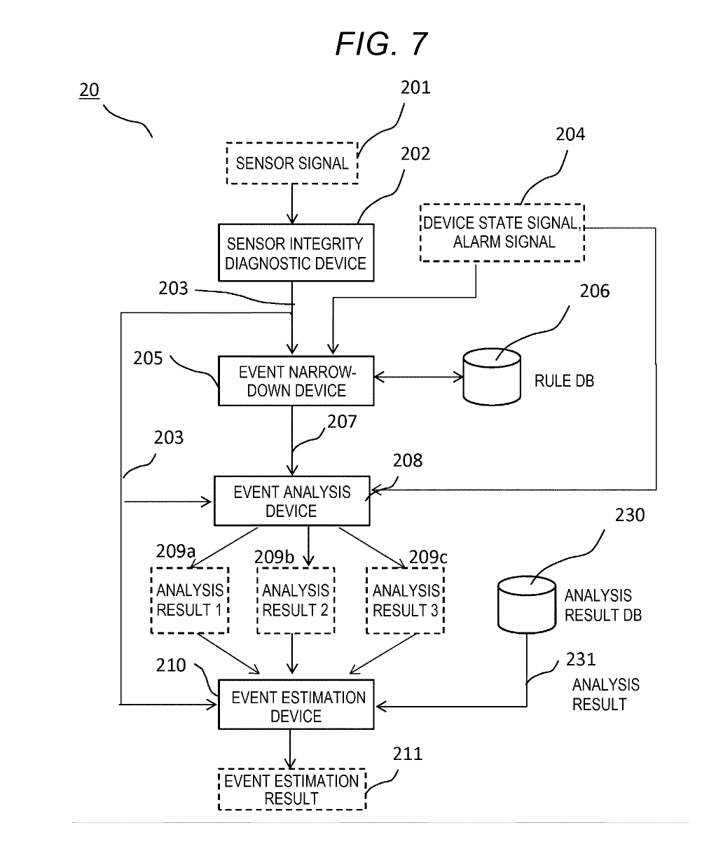

FIG. 7 shows one configuration example of an operation support system for plant accidents as example 2. The difference from FIG. 1 is in addition of an analysis result DB (database) 230 and an analysis result 231, and the rest is the same. The sensor signal 203 is not used for the analysis itself, but used for output with the analysis result.

The analysis result DB (database) 230 is a massive event database in which change patterns of a plurality of processes (corresponding to sensor signals) and events occurring within the plant are associated. The massive event database is created by generating an enormous number of abnormalities and device operations using a plant simulator in advance, for example. The analysis results (process states) associated with each of the events are input from the event analysis device 208, the event estimation device 210 compares the results and the analysis results 231, and outputs an occurring event with coincidence of them together with the sensor signal 203 and the analysis result 209 as an event estimation result 211. The comparison between the signals is the same processing as that of the event estimation device 210 shown in FIG. 1. The analyses with the varied sizes of pipe rupture are stored in the analysis result DB (database) 230, for example, as the event “HPCF pipe rupture”, the events of HPCF pipe rupture at 3%, 10%, 50% of the rupture size of the HPCF pipe are prepared, and thereby, a more detailed event estimation result may be output from the event estimation device 210. The event estimation device 210 can output the event estimation result and the sensor signal 203 (process state) to a display device (not shown). As a result, there is an advantage that coincidence of the behavior (process state) of the real plant with the event estimation result may be confirmed by comparison on the display device.

In the example, the plant states are narrowed down based on at least one of the sensor signal, the alarm signal, and the device state signal, with at least the event narrow-down result as the initial condition of the plant behavior analysis, the process state of the plant is estimated with respect to the narrowed down event candidates, the analysis result and the massive event data in which change patterns of the processes (corresponding to the sensor signals) and the events occurring within the plant are compared, and thereby, the detailed event estimation result in consideration of the rupture size of the pipe may be output with the sensor signal.

### Example 3

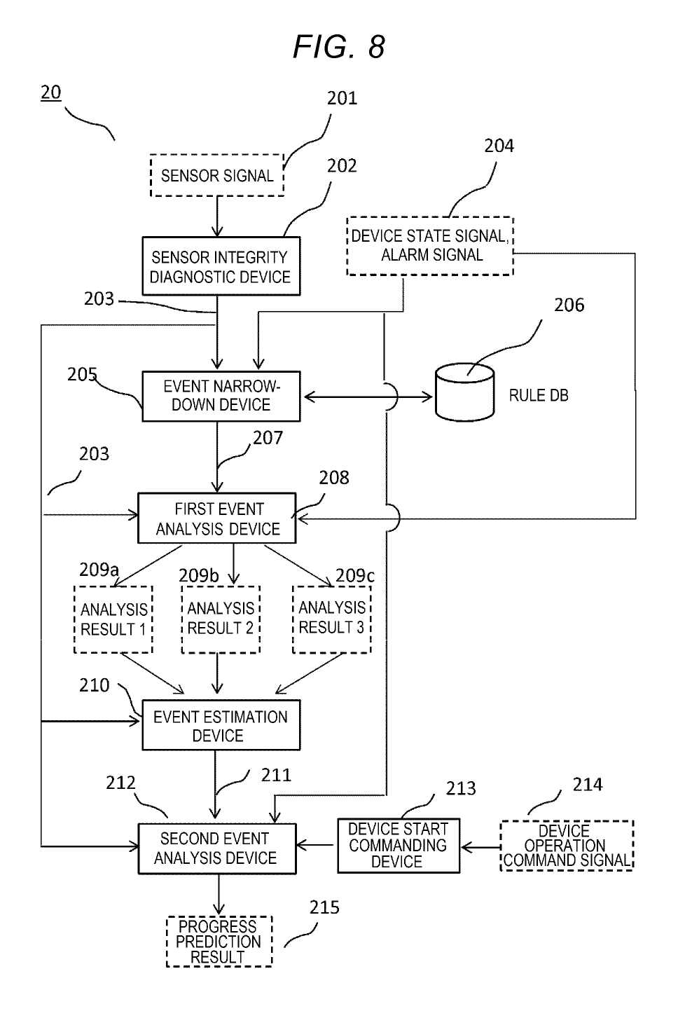

FIG. 8 shows one configuration example of an operation support system for plant accidents as example 3. The difference from FIG. 1 is in addition of a second event analysis device 212, a device start commanding device 213, a device operation command signal 214. Thereby, when the plant is brought to be safer by operation of a certain device (or devices) based on the event estimation result 211, how the plant state, i.e., the process state turns out may be analyzed as a result of the operation.

When the device operation command signal 214 is input through the operation by the operator or the technical supporter, in the device start commanding device 213, the start condition of an object device designated by the device operation command signal 214 is input to the model for the analysis of the plant behavior within the second event analysis device 212. The event estimation result 211, the alarm signal, the device state signal 204 are input, and the second event analysis device 212 analyzes the plant behavior. The alarm signal, the device state signal are provided as boundary conditions of the plant behavior analysis. That is, how the plant state turns out when a certain device is started after the event is estimated is calculated. For confirmation of the effect by starting the device, an analysis when the device is not started is performed.

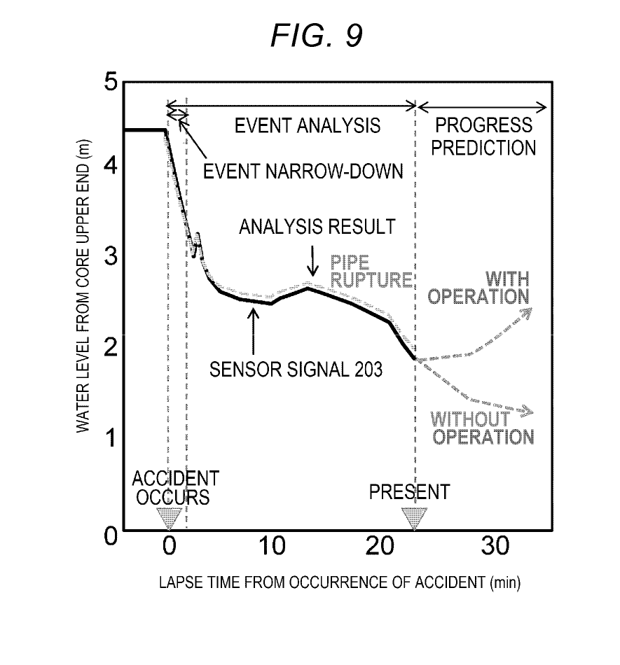

FIG. 9 shows both analysis results when the device is started (operated) and not started (operated). The second event analysis device 212 can output a progress prediction result (progress prediction result after device operation) and the sensor signal 203 (process state) to a display device (not shown). As a result, there is an advantage that coincidence of the behavior (process state) of the real plant with the progress prediction result may be confirmed by comparison on the display device. The current time is an analysis start time, and the subsequent progress prediction result 215 is output in both cases “with operation” and “without operation”. In this case, the water level from the core upper end is raised, i.e., the reactor water level is recovered by the device operation.

In the example, the progresses of the plant state (process state) when the device is operated and not operated may be predicted with respect to the event estimation result, and whether or not the plant is brought to be safer by the device operation may be predicted. In the example of FIG. 9, the recovery of the reactor water level may bring the plant to be safer. Accordingly, by installation of an operation support system for plant accidents 20 in the central control room, there is an advantage that the operator confirms the operation that may bring the plant to be safer, then, performs the operation of the plant, and thereby, may confirm the coincidence of the behavior (process state) of the real plant with the progress prediction result by comparison. Note that the second event analysis device 212 analyzes the plant behavior at the higher speed than the actual time, and thereby, the progress prediction of the process state after the event estimation may be executed in a shorter time. Further, by installation of the operation support system for plant accidents 20 in the technical support center (technical support organization) within a plant site, how the plant behaves when the device is started may be analyzed in a plurality of cases with respect to the event estimation result, the most effective device operation may be instructed to the operator in the center control room from the analysis results, and thereby, the operator may perform the operation of the plant to bring the plant to be safer. That is, the safety of the plant at accidents may be improved.

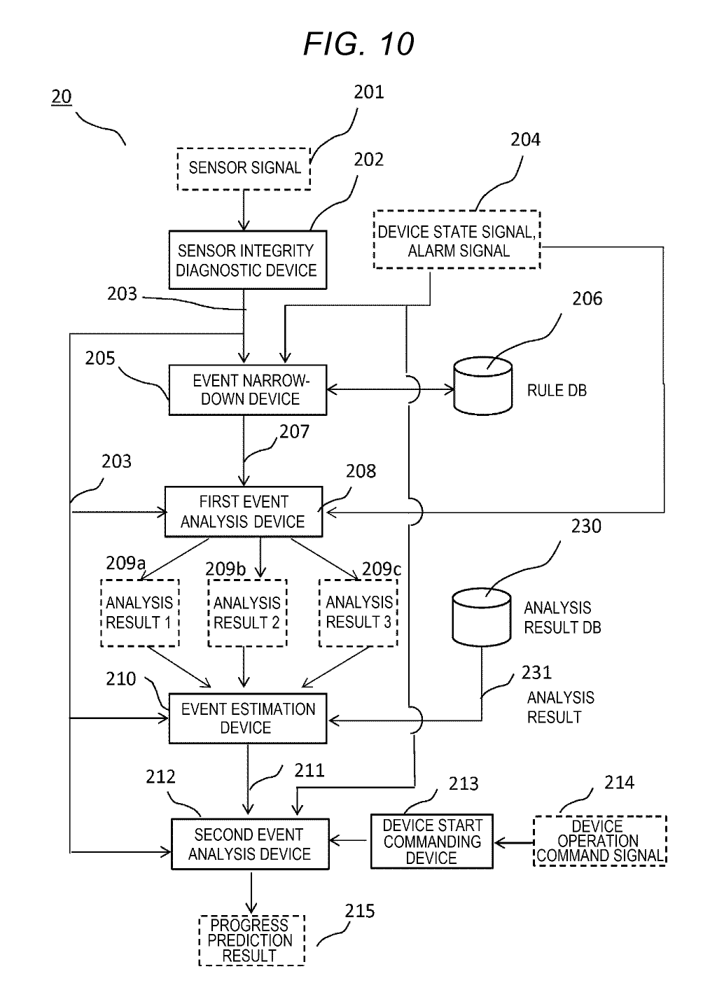

FIG. 10 shows one configuration example of an operation support system for plant accidents as example 4. The difference from FIG. 8 is in addition of an analysis result DB (database) 230 and an analysis result 231, and the rest is the same. The sensor signal 203 is not used for the analysis itself, but used for output with the analysis result.

The analysis result DB (database) 230 is a massive event database in which change patterns of a plurality of processes (corresponding to sensor signals) and events occurring within the plant are associated. The massive event database is created by generating an enormous number of abnormalities and device operations using a plant simulator in advance, for example. The analysis results (process states) associated with each of the events are input from the first event analysis device 208, the event estimation device 210 compares the results and the analysis results 231, and outputs an occurring event with coincidence of them as an event estimation result 211. The comparison between the signals is the same processing as that of the event estimation device 210 shown in FIG. 8. The analyses with the varied sizes of the pipe rupture are stored in the analysis result DB (database) 230 and, for example, as the event “HPCF pipe rupture”, the events of HPCF pipe rupture at 3%, 10%, 50% of the rupture size of the HPCF pipe are prepared. Therefore, a more detailed event estimation result may be output from the event estimation device 210.

When the device operation command signal 214 is input through the operation by the operator or the technical supporter, the device start commanding device 213 inputs the start condition of an object device designated by the device operation command signal 214 to the model for the analysis of the plant behavior within the second event analysis device 212. The more detailed event estimation result 211, sensor signal 203, alarm signal, device state signal 204 are input, and the second event analysis device 212 analyzes the plant behavior. The sensor signal, the alarm signal, the device state signal are provided as boundary conditions of the plant behavior analysis. That is, how the plant state turns out when a certain device is started after the detailed event is estimated is calculated. For confirmation of the effect by starting the device, an analysis when the device is not started is performed. The second event estimation device 212 can output a progress prediction result (progress prediction result after device operation) and the sensor signal 203 (process state) to a display device (not shown). As a result, there is an advantage that coincidence of the behavior (process state) of the real plant with the progress prediction result may be confirmed by comparison on the display device.

In the example, the progresses of the plant state (process state) when the device is operated and not operated may be predicted with respect to the detailed estimation result, and the operator or the technical supporter may determine whether or not to bring the plant to be safer by the device operation.

Note that the invention is not limited to the above described examples, but includes various modified examples. For example, the above described examples are explained in detail for clear explanation, and the invention is not necessarily limited to an embodiment having all of the explained configurations.

### Example 5

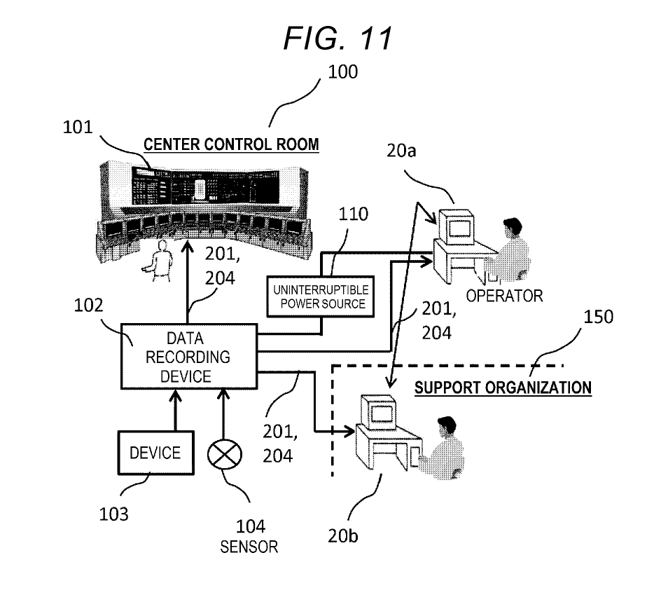

FIG. 11 shows a configuration example of a nuclear plant system to which the operation support system for plant accidents according to examples 1 to 4 is applied. In the example, operation support systems for plant accidents 20a, 20b are installed in a center control room 100 and a support organization 150 commanded by a director of the site, e.g., an important earthquake-proof building. To the operation support system for plant accidents 20a installed in the center control room 100, power is supplied via an uninterruptible power source 110. To the operation support system for plant accidents 20b in the support organization, power is supplied from an emergency power source. A data recording device 102 also serving as a process calculator provided in the center control room 100 takes in state signals from sensors 104 and devices 103, performs processing of unit conversion and the like thereon, and outputs sensor signals 201, device state signals, alarm signals 204 to a main control bench board 101 and the operation support systems for plant accidents 20a, 20b. Not only in the center control room 100 with operators, but the operation support system for plant accidents 20b is installed in the support organization 150, and thereby, information may be shared. Further, in the operation support system for plant accidents 20b installed in the support organization 150, performance of the event analysis device 208 that analyzes the process state after an accident occurs may be higher in view of the space and power supply than that in the operation support system for plant accidents 20a installed in the center control room 100. By the operation support system for plant accidents 20b that may perform more event progress prediction evaluations, more preferable operation at accidents may be determined from a plurality of accident responses, and the result may be immediately transmitted from the support organization 150 to the operators in the center control room 100.

According to the invention, an event may be estimated in reflection of a plant state changing momentarily at a plant accident and a plant state (process state) with or without device operation may be further predicted with respect to the estimated event, and thus, the industrial value is extremely high.

1. An operation support system for plant accidents comprising:
an event narrow-down device that narrows down occurring event candidates based on at least one of a sensor signal, a device state signal, and an alarm signal and a discriminant rule;
an event analysis device that analyzes a plant behavior based on a plurality of event narrow-down results as output of the event narrow-down device, the sensor signal, the device state signal, and the alarm signal; and
an event estimation device that estimates an occurring event by comparing an analysis result from an analysis of a process state as output of the event analysis device and the sensor signal,
wherein the event estimation device outputs the analysis result of the process state and the sensor signal corresponding to the occurring event as an event estimation result.

2. An operation support system for plant accidents comprising:
an event narrow-down device that narrows down occurring event candidates based on at least one of a sensor signal, a device state signal, and an alarm signal and a discriminant rule; and
an event analysis device that analyzes a plant behavior based on a plurality of event narrow-down results as output of the event narrow-down device, the sensor signal, the device state signal, and the alarm signal,
wherein an analysis result from an analysis of a process state as output of the event analysis device and event data in which change patterns of a plurality of process states and events occurring within a plant are associated are compared and both an analysis result corresponding to an occurring event with coincidence between the pattern and the data and the sensor signal are output as an event estimation result.

3. An operation support system for plant accidents comprising:
an event narrow-down device that narrows down occurring event candidates based on at least one of a sensor signal, a device state signal, and an alarm signal and a discriminant rule;
a first event analysis device that analyzes a plant behavior based on a plurality of event narrow-down results as output of the event narrow-down device, the sensor signal, the device state signal, and the alarm signal;
an event estimation device that estimates an occurring event by comparing an analysis result from an analysis of a process state as output of the first event analysis device and the sensor signal; and
a second event analysis device that predicts a progress of a plant state after estimation of the occurring event using an event estimation result output from the event estimation device, the alarm signal, the device state signal, and a device start command as an initial condition of the plant behavior analysis,
wherein the analysis results of the process state when device operation is performed and not performed and the sensor signal are output from the second event analysis device.

4. An operation support system for plant accidents comprising:
an event narrow-down device that narrows down occurring event candidates based on at least one of a sensor signal, a device state signal, and an alarm signal and a discriminant rule;
a first event analysis device that analyzes a plant behavior based on a plurality of event narrow-down results as output of the event narrow-down device, the sensor signal, the device state signal, and the alarm signal;
an event estimation device that estimates an occurring event by comparing an analysis result from an analysis of a process state as output of the first event analysis device and event data in which change patterns of a plurality of process states and events occurring within a plant are associated; and
a second event analysis device that predicts a progress of the plant state after estimation of the occurring event using an event estimation result output from the event estimation device, the alarm signal, the device state signal, and a device start command as an initial condition of the plant behavior analysis,
wherein the analysis results of the process state when device operation is performed and not performed and the sensor signal are output from the second event analysis device.

5. The operation support system for plant accidents according to claim 1, wherein the event analysis device has an automatic start condition of a device of a safety system and has a function of starting at least the device of the safety system and analyzing the plant behavior when the sensor signal representing the process state exceeds the automatic start condition.

6. The operation support system for plant accidents according to claim 1, wherein the event narrow-down device narrows down the event candidates based on the sensor signal, the device state signal, the alarm signal, and the discriminant rule.
